(19) United States
(12) Patent Application Publication
(10) Pub. No.: US 2005/0234202 A1
(43) Pub. Date: Oct. 20, 2005

(54) Modifier for polycarbonate/acrylonitrile-butadiene-styrene blends

(76) Inventor: Xiyun Serene Fan, Newark, DE (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 10/973,701

(22) Filed: Oct. 26, 2004

Related U.S. Application Data
(60) Provisional application No. 60/516,492, filed on Oct. 30, 2003.

(51) Int. Cl. C08L 69/00

(52) U.S. Cl. 525/468; 525/461

(57) ABSTRACT

This invention is a PC/ABS blend consisting essentially of 15 wt % or less of a modifier blend, wherein the modifier blend comprises an ethylene/alkyl acrylate copolymer and an ethylene/butyl acrylate/glycidyl methacrylate (GMA) terpolymer.

This application claims the benefit of U.S. Provisional Application No. 60/516,492, filed Oct. 30, 2003.

### BACKGROUND OF THE INVENTION

1. Field of the Invention

This invention relates to modifiers for polycarbonate polymer blends.

2. Description of the Prior Art

Polycarbonate (PC) blends with acrylonitrile/butadiene/styrene (ABS) terpolymers are used in various applications. However, blends of this composition can have problems with processibility, toughness, streaks, delamination, and low temperature performance.

Elvaloy® is a terpolymer comprising ethylene, butyl acrylate, and glycidyl methacrylate. Elvaloy® AC is a terpolymer comprising ethylene and methacrylate monomers. Elvaloy® and Elvaloy® AC have each been used as a modifier for toughening PC/ABS blends, but the polymer obtained in either case can have delamination problems and streaks when used in an injection molding process. As a result, Elvaloy® AC, as a PC/ABS modifier, has problems when used in applications having a PC content of at least 50 wt %.

It can be desirable to modify PC/ABS blends having greater than 50 wt % polycarbonate with a modifier that will improve at least one of the problems areas without detriment to other properties.

### SUMMARY OF THE INVENTION

In one aspect, the present invention is a PC/ABS blend consisting essentially of 15 wt % or less of a modifier blend, wherein the modifier blend comprises an ethylene/(meth)acrylate copolymer and an ethylene/butyl acrylate/glycidyl methacrylate (GMA) terpolymer.

In another aspect, the present invention is an article comprising a PC/ABS blend consisting essentially of 15 wt % or less of a modifier blend, wherein the modifier blend comprises an ethylene/(meth)acrylate copolymer and an ethylene/butyl acrylate/glycidyl methacrylate (GMA) terpolymer.

In another aspect, the present invention is a process of injection molding a PC/ABS blend to form an article, the process comprising the steps of: injection molding the blend, wherein the blend is PC/ABS blend consisting essentially of 15 wt % or less of a modifier blend, wherein the modifier blend comprises an ethylene/(meth)acrylate copolymer and an ethylene/butyl acrylate/glycidyl methacrylate (GMA) terpolymer, and wherein the blend is extruded at a melt temperature of at least about 270° C., and a screw speed greater than about 200 rpm.

### DETAILED DESCRIPTION OF THE INVENTION

In one embodiment, the present invention is a modifier blend comprising or consisting essentially of an ethylene alkyl acrylate copolymer and an ethylene/n-butyl acrylate/glycidyl methacrylate terpolymer. Preferably the ethylene/alkyl acrylate copolymer is a terpolymer. More preferably the ethylene/alkyl acrylate copolymer comprises methyl acrylate as the alkyl acrylate component. Other components may be included with the modifier blend depending on their utility and benefit in the application described. However not all components are innocuous when included in blends of the present invention, and the deleterious effects that can result should be considered as well as the benefits. The modifier blends of the present invention is useful for lowering the viscosity of PC/ABS blends used in injection molding, and reducing defects such as delamination and streaking in a part molded from PC/ABS blends. The modifier blends of the present invention can comprise from about 50 wt % to about 90 wt % of the E/AA component, and more preferably from about 60 wt % to about 75 wt % of the E/AA component. Most preferably the blend comprises from about 65 wt % to about 75 wt %. Either too high or too low of a ratio can lead to delamination problems in a molded part. The modifier blend is included in the PC/ABS blend in an amount of less than or equal to about 15 wt %, based on the weight of the total PC/ABS blend. Preferably, the modifier blend is present in an amount of 7 wt % or less, more preferably 5 wt % or less. Higher levels of modifier may tend to coarsen the additive domain and lower the performance of the blend in the injection molded article.

In another embodiment, the present invention is a PC/ABS blend comprising the modifier of the present invention. A PC/ABS blend of the present invention comprises a modifier blend that comprises a copolymer of ethylene and an alkyl acrylate and an ethylene/butyl acrylate/glycidyl methacrylate (GMA) terpolymer. Suitable ethylene/alkyl acrylate copolymers are, for example, Elvaloy® 1125AC, which comprises 25 wt % methyl acrylate or Elvaloy® 1330AC which comprises 30 wt % methyl acrylate, both of which are commercially available from E.I. DuPont de Nemours and Company. Other ethylene alkyl acrylate copolymers can also be suitable for use in the practice of the present invention, as well. Suitable ethylene/n-butyl acrylate/GMA terpolymers are, for example, Elvaloy® PTW, which is commercially available from E.I. DuPont de Nemours and Company.

The PC/ABS blends of the present invention can comprise from about 1 wt % to about 99 wt % polycarbonate, and from about 99 wt % to about 1 wt % ABS based on the total weight of the PC/ABS blend. However, the most significant improvement obtained using a modifier of the present invention can be observed when injection molding blends comprising at least about 50 wt % polycarbonate in the blend.

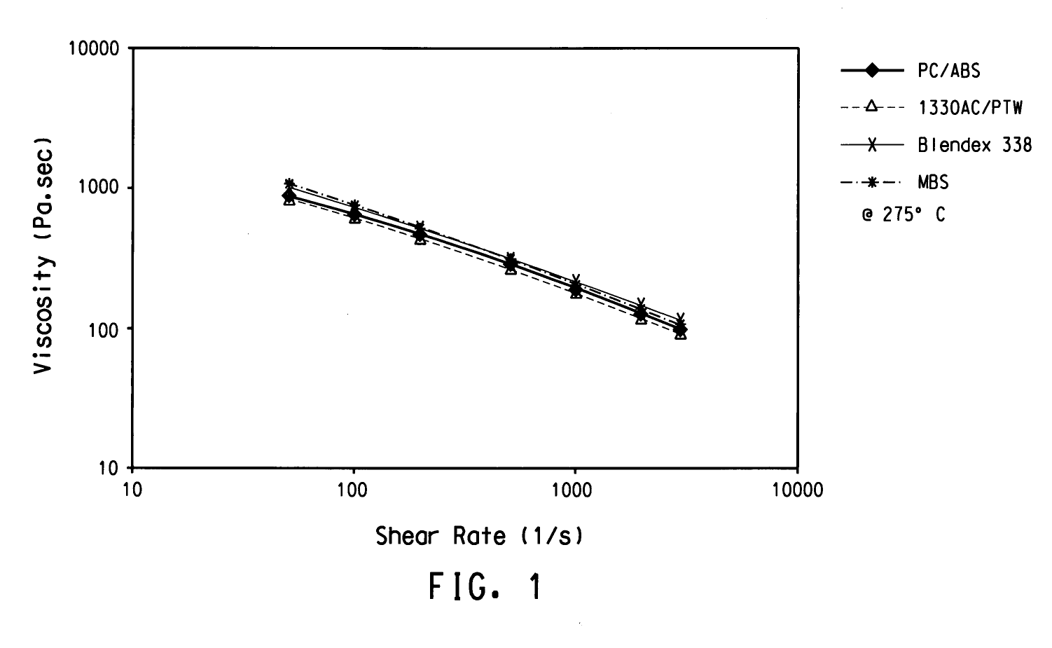

Using one of the modifier components alone in a PC/ABS blend can provide improved molded parts when the polycarbonate is less than 50 wt % of the blend. However, streaks and delamination can occur in a molded PC/ABS part if polycarbonate is at least 50 wt % of the blend when a conventional modifier is used, rather than a modifier blend of the present invention. Blends of the present invention have lower viscosity than the unmodified blends or blends modified using convention modifiers (see FIG. 1). Increased viscosity of a PC/ABS blend can be a factor in the onset of delamination in an extruded article.

In another embodiment, the present invention is a process for injection molding a composition of the present invention. While it is a goal of the presently claimed invention to modify PC/ABS compositions such that streaks and delamination problems are diminished in a molded article, it has surprisingly been found that delamination can be related to the injection molding process. In the practice of the present invention, a modified PC/ABS blended composition is preferably injection molded at a temperature of greater than about 270° C. Preferably, the injection molding process is carried out a temperature of from about 270° C. to about 280° C. Below an injection molding temperature of about 270° C. the part obtained may be more susceptible to delamination. Above a temperature of about 280° C. the polymer blend may be exposed to an unnecessarily high heat history.

In the practice of the present invention, the screw speed at which the polycarbonate blend is extruded is at least about 200 rpm, and preferably at least about 225 rpm. Even more preferably, the screw speed is at least about 250 rpm.

In another embodiment, the present invention is an article comprising the modified PC/ABS blends of the present invention. Modified PC/ABS blends of the present invention can be used in applications where PC/ABS blends are conventionally used to make injection molded parts. For example, blends of the present invention can be used: in parts for the computer industry such as casings for keyboards, keyboard keypad, printers, scanners, computer monitors, computer casings, and other computer peripherals; for parts useful in the transportation industry including the automobile industry, aircraft industry, shipping/boating industry, and railroad industry, as body panels or parts, seats, accessories, instrument panels and the like; in appliances such as ovens including conventional ovens and microwave ovens, refrigerators, dish washers, freezers, washers, dryers; in home entertainment systems including televisions, video cassette players and recorders, digital video players and recorders, compact disc players, and the like; telephones and cellular phone parts including the body, the handset, the keypad; toys, sporting equipment, and many other applications where PC/ABS blends find use.

### EXAMPLES

The Examples are for illustrative purposes only, and are not intended to limit the scope of the invention.

### Example 1

A blend of polycarbonate (Calibre 201-10 available from Dow Chemical) and ABS (Magnum AG700, available from Dow Chemical) were compounded using a twin screw extruder (250 rpm) at a temperature of 280° C. in a 70:30 ratio, and 3.5 wt % Elvaloy® 1330AC and 1.5 wt % Elvaloy® PTW were dry blended with the mixture. Plaques were injection molded at from 270 to 280° C., using a fast injection rate. Notched Izod (ft-lb/in) was determined at 23° C., 0° C., −20° C., and −40° C. and reported in Table 1a. Tensile Strength, Tensile Elongation, Flexural Modulus, % Elongation @ break, and Break Stress were determined at 23° C., and are reported in Table 1b.

### Example 2

The procedures of Example 1 were followed except that 3.75 wt % of Elvaloy® 1330AC was blended with 1.25 wt % of Elvaloy® PTW were dry blended.

### Comparative Example 1

A blend of polycarbonate (Calibre 201-10 available from Dow Chemical) and ABS (Magnum AG700, available from Dow Chemical) was obtained in a 70:30 ratio, and 5 wt % Elvaloy® 1330AC was blended with the mixture. Plaques were injection molded at from 270 to 280° C., using a fast injection rate. Notched Izod (ft-lb/in) was determined at 23° C., 0° C., −20° C., and −40° C. and reported in Table 1a. Tensile Strength, Tensile Elongation, Flexural Modulus, % Elongation @ break, and Break Stress were determined at 23° C., and are reported in Table 1b.

### Comparative Example 2

A blend of polycarbonate (Calibre 201-10 available from Dow Chemical) and ABS (Magnum AG700, available from Dow Chemical) was obtained in a 70:30 ratio. Plaques were injection molded at from 270 to 280° C., using a fast injection rate. Notched Izod (ft-lb/in) was determined at 23° C., 0° C., −20° C., and −40° C. and reported in Table 1a. Tensile lo Strength, Tensile Elongation, Flexural Modulus, % Elongation @ break, and Break Stress were determined at 23° C., and are reported in Table 1b.

### Comparative Example 3

A blend of polycarbonate (Calibre 201-10 available from Dow Chemical) and ABS (Magnum AG700, available from Dow Chemical) was obtained in a 70:30 ratio, and 5 wt % Blendex 338 (from GE) was blended with the mixture. Plaques were injection molded at from 270 to 280° C., using a fast injection rate. Notched Izod (ft-lb/in) was determined at 23° C., 0° C., −20° C., and −40° C. and reported in Table la. Tensile Strength, Tensile Elongation, Flexural Modulus, % Elongation @ break, and Break Stress were determined at 23° C., and are reported in Table 1b.

TABLE 1a

| | Notched Izod | Notched Izod | Notched Izod | Notched Izod |
|---|---|---|---|---|
| Ex | @ 23° C. | @ 0° C. | @ −20° C. | @ −40° C. |
| 1 | 18.0 | 16.7 | 15.3 | 7.4 |
| 2 | 24.9 | 27.3 | 16.6 | — |
| C1 | 14.6 | 15.0 | 12.9 | 5.7 |
| C2 | 14.3 | 12.4 | 11.3 | 8.9 |
| C3 | 13.2 | 12.8 | 11.6 | 9.2 |

TABLE 1b

| | Tensile | Break | % | Flexural |
|---|---|---|---|---|
| | Strength | Stress | Elongation | Modulus |
| Ex | (psi) | (psi) | @ Break | (kpsi) |
| 1 | 7889 | 7049 | 126 | 343 |
| C1 | 7928 | 6991 | 132 | 346 |
| C2 | 8930 | 8798 | 132 | 380 |
| C3 | 7861 | 6862 | 77 | 348 |

1. A polycarbonate blend consisting essentially of 15 wt % or less, based on the total weight of the polycarbonate blend, of a modifier blend wherein the modifier blend comprises an ethylene/alkyl acrylate copolymer and an ethylene/butyl acrylate/glycidyl methacrylate (GMA) terpolymer.

2. The blend of claim 1 wherein the polycarbonate blend comprises acrylonitrile/butadiene/styrene (ABS).

3. The blend of claim 2 wherein the blend comprises at least about 50 wt % polycarbonate, based on the weight of the polycarbonate and ABS components.

4. The blend of claim 3 wherein the modifier blend is present in an amount of 7 wt % or less.

5. The blend of claim 4 wherein the modifier blend is present in an amount of 5 wt % or less.

6. The blend of claim 5 wherein the ethylene/alkyl acrylate copolymer is an ethylene methyl acrylate copolymer.

7. An article comprising the composition of claim 1.

8. The article of claim 7 wherein the polycarbonate blend additionally comprises acrylonitrile/butadiene/styrene (ABS) terpolymer.

9. The article of claim 4 wherein the article is formed by injection molding.

10. A process for injection molding a PC/ABS blend to form an article, the process comprising the steps of: injection molding the blend, wherein the blend is a PC/ABS blend consisting essentially of 15 wt % or less of a modifier blend, wherein the modifier blend comprises an ethylene/(meth)acrylate copolymer and an ethylene/butyl acrylate/glycidyl methacrylate (GMA) terpolymer, and wherein the blend is extruded at a melt temperature of at least about 270° C., and a screw speed greater than about 200 rpm.
